(19) United States
(12) Patent Application Publication
(10) Pub. No.: US 2013/0087056 A1
(43) Pub. Date: Apr. 11, 2013

(54) ELECTRIC PRESS FOR CUT FILLER COMPRESSION

(71) Applicant: Wojciech Jerzy Chojnacki, Radom (PL)

(72) Inventor: Wojciech Jerzy Chojnacki, Radom (PL)

(73) Assignee: International Tobacco Machinery Poland Sp. Z.O.O., Radom (PL)

(21) Appl. No.: 13/703,664

(22) PCT Filed: Jul. 6, 2011
(86) PCT No.: PCT/PL2011/000071

§ 371 Date: Dec. 17, 2012

(30) Foreign Application Priority Data
Jul. 8, 2010 (PL) P.391785

(51) Int. Cl. B30B 9/30

(52) U.S. Cl. CPC B30B 9/3003
USPC 100/295

(57) ABSTRACT

The object of the invention is an electric press for the compression of tobacco cut filler provided with at least one electric motor (1) and a control unit (2) driving a movable compressing element (3) by means of a drive train (4) characterised in that the compressing element (3) of the piston rod has an openwork design and is driven while keeping controllable driving torque.

The object of the invention is an electric press for the compression of cut filler used for cigarette manufacturing.

Cut filler may be stored and transported in boxes, where it is usually compressed so as to utilize the volume of the box to the maximum extent. For cut filler compression, presses with hydraulic and pneumatic drive are commonly used. A high degree of cut filler compression requires the use of actuators with a large working stroke. Hydraulic presses ensure low motion speeds and entail the hazard of product contamination with working liquid, whereas known press design solutions using pneumatic actuators require highly efficient air supply systems, and the control of the motion speed and the piston rod thrust requires complicated control systems. An alternative solution is double compression, where before the second compression additional cut filler feeding takes place, using an actuator with a shorter working stroke.

From the publication U.S. Pat. No. 4,572,065 a press driven by a hydraulic actuator is known in which the compressing element is a heavy metal plate with rectangular shape. The compression takes place in two stages, where the air is sucked off from the compression chamber, and the plate being the compressing element is supposed to assist pressing of cut filler. After the compression, a bale of tobacco or cut filler is pulled out of the compression chamber.

On the other hand, from the publication DE 34 05 182 a solution is known in which cut filler is pressed directly in the box in which it will be stored or transported. The bottom part of a charging hopper is inserted into the box and it will be removed after the compression of cut filler. The part of the charging hopper inserted into the box is provided with an air removal system.

From the publication WO 2005/013732 a cut filler press provided with a flat solid plate driven by four chains with a special construction for applying pressure at the corners of the plate is known.

On the other hand, the publication U.S. Pat. No. 3,782,275 discloses a lightweight design of the compressing element of a press for forming hay bales. The compressing element consists of several elements forming a common compression surface.

In view of the expectation of manufacturers that the pressing process is as short as possible, the motion of the compressing element to reach cut filler should take place at high speed, but in the last phase of the motion the speed should be reduced so as not to cause rising of dust. The effect of rising dust in known solutions using non-openwork compressing elements without reducing the motion speed of these elements is caused by the fact that the air from under the compressing element is squeezed with a considerable speed through the slit around said element formed by the compressing element and the wall of the compression chamber or the box.

Furthermore, while compressing cut filler we have to deal with the impact of cut filler on side walls of the box, which results in bulging of the walls. The effect of stretching the walls of the box is particularly visible in case of uneven filling with cut filler before the compression.

While compressing cut filler, with decreasing layer of cut filler, greater and greater compressing force applied on cut filler by the compressing element is necessary. When applying constant pressure, the compression process became longer due to the time needed for permanent deformation of tobacco fibres.

A problem that has been solved by the present invention is the optimisation of kinematic characteristics of the compressing element, the optimisation of compression parameters with simultaneous elimination of the effect of bulging walls of the box.

The substance of the invention is a press for the compression of tobacco cut filler provided with at least one electric motor and a control unit driving a movable compressing element by means of a drive train. According to the invention, the compressing element which the press is provided with has an openwork design and is driven while keeping controllable torque.

A press according to the invention is characterised in that the electric motor of the press is a synchronous motor.

A press according to the invention is characterised in that the compressing element is driven while keeping constant driving torque of the motor.

A press according to the invention is characterised in that the drive train includes a driving chain.

A press according to the invention is characterised in that the compressing element has the shape of a frame with transverse bars.

A press according to the invention is characterised in that the dimensions of the compressing element are considerably smaller than the cross-section of a tobacco mass compression chamber.

The solution according to the invention enables the compressing element to make quick motions before the commencement of compression, optimised control of the compression force of the compressing element and quick withdrawal of the compressing element. The structure of the compressing element ensures that the box in which the compression takes place is not deformed.

The object of the invention was shown in preferred embodiments in the drawing in which:

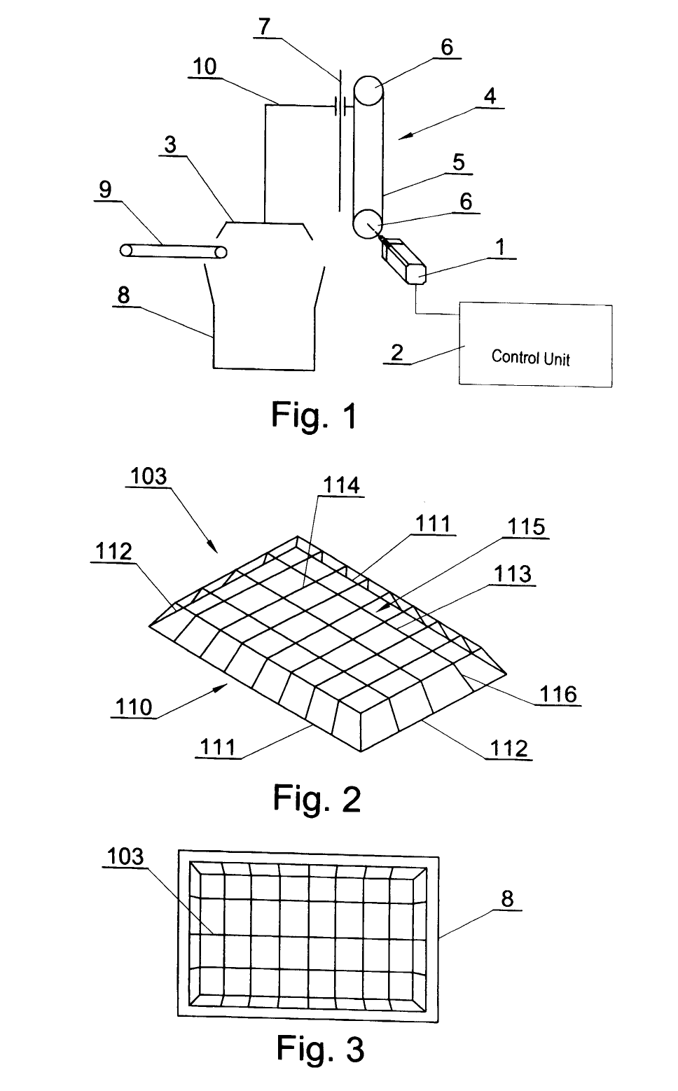

FIG. 1 shows a kinematic diagram of a press,

FIG. 2 shows a compressing element in a first embodiment,

FIG. 3 shows a top view of a box with a compressing element situated inside,

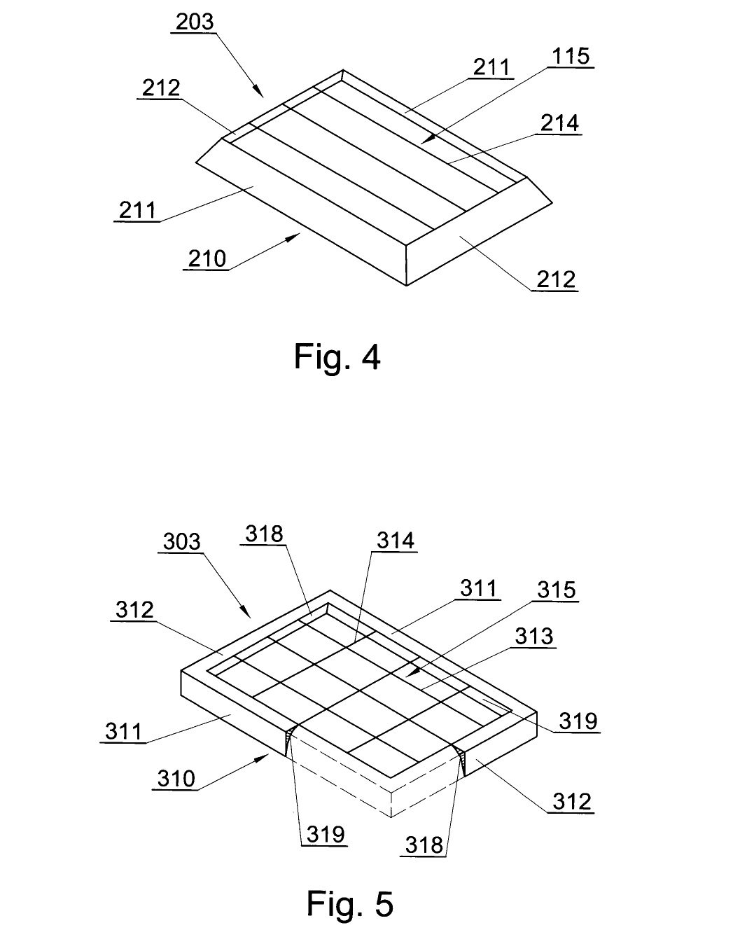

FIG. 4 shows a compressing element in a second embodiment,

FIG. 5 shows a compressing element in a third embodiment,

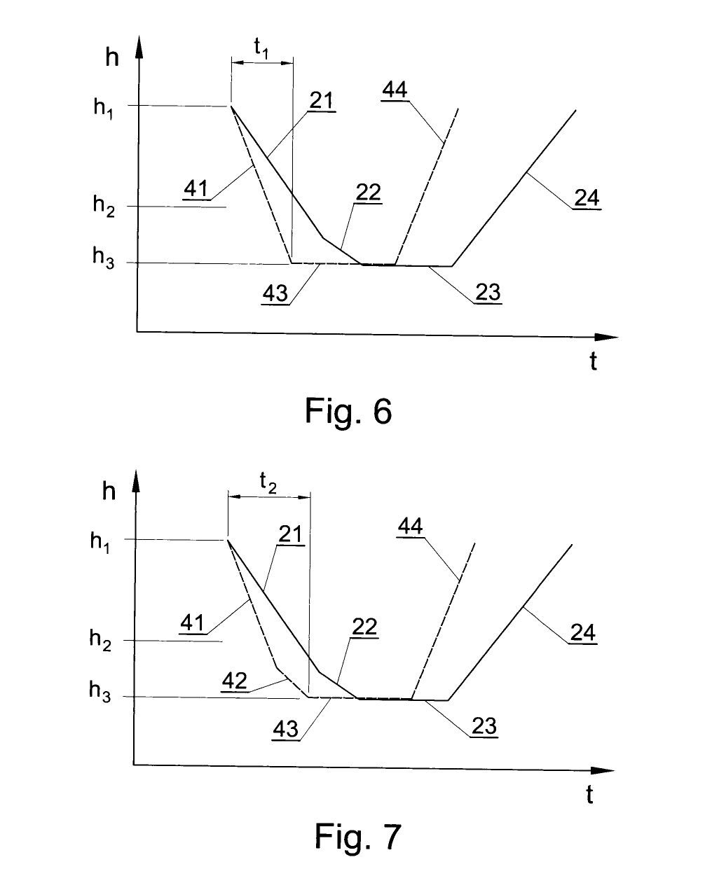

FIGS. 6 and 7 show performance characteristics of a press with a pneumatic actuator drive and a press according to the present invention,

FIG. 1 shows a kinetic diagram of a press in which the drive is realised by an electric motor 1 controlled by a control unit 2. The drive from the motor 1 is transmitted to a compressing element 3 by a drive train 4 which may be provided with a chain 5 and chain wheels 6. The compressing element can move together with a slider 10 vertically along a guide 7 and sink in a box 8. In the space between the compressing element 3, shown in FIG. 1 in its upper position, and the box 8, conveyor 9 feeding cut filler to the box 8 is situated. In FIG. 1, the conveyor 9 is in a position enabling it to feed cut filler to the box 8.

In order to fill the box 8 with cut filler and to compress it, the box 8 is put under the press so that the compressing element can slip inside the box 8. After putting the box 8, the conveyor 9 is moved so that cut filler, fed by it, falls inside the box. After feeding a portion of tobacco cut filler, the conveyor 9 is withdrawn in order to make a motion of the compressing element 3 possible.

FIG. 2 shows a compressing element 103 in a first embodiment. A frame 110 of the compressing element consists of two longitudinal elements 111 and two transverse elements 112. A central raised part 115 of the compressing element 103 is built of longitudinal elements 113 and transverse elements 114. The central part 115 of the element and the frame 110 are connected by means of diagonally positioned couplers 116. For reasons of simplification, the elements connecting the compressing element 103 with the slider 10 of the drive train 4 have not been shown.

In the course of compression, cut filler, as a three-dimensional structure in which the fibres catch hold of each other, acts like a sponge. Diagonally positioned couplers 116 belonging to the frame 110 of the compressing element 103 cause that tobacco cut filler is to some extent moved away from the walls of the box. In the course of compression, the air accumulated within tobacco cut filler escapes through the open-work central part 115.

FIG. 3 shows a top view of the box 8 with the compressing element 103 placed inside. The overall dimensions of the compressing element may be smaller than in case of known solutions where the compressing element fills the compression chamber with a minimum clearance.

FIG. 4 shows a compressing element 203 in a second embodiment. A frame 210 of the compressing element consists of two flat inclined longitudinal elements 211 and two flat inclined transverse elements 212. A central part 215 of the compressing element is built of longitudinal elements 213 connected with transverse elements 212.

Diagonally positioned elements 211 and 212 belonging to the frame 210 of the compressing element 203 cause that during compression the tobacco cut filler is to some extent moved away from the walls of the box. During compression, the air accumulated within tobacco cut filler escapes through the openwork central part 215.

FIG. 5 shows a compressing element 303 in a third embodiment. A frame 310 of the compressing element 303 consists of two longitudinal elements 311 with arched inner surfaces 319 and two transverse elements 212 with arched inner surfaces 318. A central part 315 of the compressing element is built of longitudinal elements 313 and transverse elements 314 connected with the elements 311 and 312.

Arched surfaces 318 and 319 of the elements 311 and 312 belonging to the frame 310 of the compressing element 303 cause that during compression the tobacco cut filler is to some extent moved away from the walls of the box. During compression, the air accumulated within tobacco cut filler escapes through the openwork central part 315.

FIGS. 6 and 7 show a comparison of exemplary simplified performance characteristics of a press with the use of a pneumatic actuator and a press according to the present invention. The vertical axis of the diagram shows the position of the compressing element in relation to the bottom of the compression chamber or the box, the horizontal axis is a time axis. The characteristics relates to a shift of the compressing element from a height h₁ corresponding to an upper position of the compressing element to a height h₂ corresponding to the height of a compressed bale of cut filler and the return of the compressing element to the initial position, i.e. to the height h₁. The height of loosely filled cut filler before compression has been marked with h₃. The compression process may be divided into three phases:
a pushing the compressing element close to cut filler and compression of cut filler,
b keeping cut filler in compressed state until the moment when cut filler loses resilience, i.e. the fibres of cut filler will be permanently deformed, so that the upper surface of the bale of compressed cut filler will not rise after withdrawing the compressing element,
c withdrawal of the compressing element.

The section 21 (FIG. 6) of the diagram shows a shift of the compressing element driven by a pneumatic actuator including pushing the compressing element close to cut filler and the commencement of compression, and the section 22 shows further shifting of the compressing element until the moment when the resistance of partly compressed cut filler increases; fragments 21 and 22 correspond to the phase a. The section 23 corresponds to the phase b, and the section 24 to the phase c of the compression process. The section 41 of the diagram shows a shift of the compressing element driven by an electric motor. The motor is controlled by the control unit in such a way as to move the compressing element with a constant speed, i.e. its driving torque, thus the compression force of the compressing element, are adjusted to growing resistance of compressed cut filler. The section 41 corresponds to the phase a, the section 43 to the phase b, whereas the section 44 to the phase c of the compression process.

FIG. 7 shows sections 21, 22, 23 and 24 describing a shift of the compressing element driven by a pneumatic actuator as in FIG. 6 as well as sections 41, 42 43 and 44 describing a shift of the compressing element driven by a press according to the present invention. The section 41 relating to the first part of the phase a, shows a shift of the compressing element including pushing the element close to cut filler and the commencement of compression until the moment when the resistance of compression is lower than the force which may be applied by the compressing element. The section 42 shows a shift of the compressing element having impact on cut filler with a constant force resulting from the applied constant driving torque of the motor. The time t₂ necessary for the compression of cut filler to the height h₂ is longer than the time t₁ in case of shifting the compressing element with a constant speed, nevertheless, the total time of the compression process is shorter than in case of compression by means of a press driven by a pneumatic actuator.

1-6. (canceled)

7. An electric press for the compression of tobacco cut filler provided with
at least one electric motor and a control unit driving a movable compressing element by means of a drive train
characterized in that the compressing element has an openwork design comprising flat, inclined longitudinal elements and is driven while keeping controllable driving torque.

8. The press according to claim 7 wherein the electric motor is a synchronous motor.

9. The press according to claim 7 wherein the compressing element is driven while keeping a constant driving torque of the motor.

10. The press according to claim 8 wherein the compressing element is driven while keeping a constant driving torque of the motor.

11. The press according to claim 7 wherein the drive train includes a driving chain.

12. The press according to claim 8 wherein the drive train includes a driving chain.

13. The press according to claim 9 wherein the drive train includes a driving chain.

14. The press according to claim 20 wherein the drive train includes a driving chain.

15. The press according to claim 7 wherein the compressing element has the shape of a frame with transverse bars.

16. The press according to claim 8 wherein the compressing element has the shape of a frame with transverse bars.

17. The press according to claim 9 wherein the compressing element has the shape of a frame with transverse bars.

18. The press according to claim 10 wherein the compressing element has the shape of a frame with transverse bars.

19. The press according to claim 15 wherein the dimensions of the compressing element are considerably smaller than the cross-section of the tobacco mass compression chamber.

20. The press according to claim 16 wherein the dimensions of the compressing element are considerably smaller than the cross-section of the tobacco mass compression chamber.

21. The press according to claim 17 wherein the dimensions of the compressing element are considerably smaller than the cross-section of the tobacco mass compression chamber.

22. The press according to claim 18 wherein the dimensions of the compressing element are considerably smaller than the cross-section of the tobacco mass compression chamber.
